(19) United States
(12) Patent Application Publication
(10) Pub. No.: US 2013/0050615 A1
(43) Pub. Date: Feb. 28, 2013

(54) LOCAL DIMMING BACKLIGHT UNIT AND DISPLAY DEVICE INCORPORATING SAME

(71) Applicant: Stefan ROHRMOSER, Oxford (GB)

(72) Inventor: Stefan ROHRMOSER, Oxford (GB)

(73) Assignee: SHARP KABUSHIKI KAISHA, Osaka (JP)

(21) Appl. No.: 13/215,505

(22) Filed: Aug. 23, 2011

(51) Int. Cl. G02F 1/13357; F21V 7/04

(52) U.S. Cl. 349/64; 362/606; 349/62

(57) ABSTRACT

A backlight unit includes a light source and at least one modular light guide plate (LGP) element that guides light from the light source. The modular LGP element has a first surface and a plurality of pins integrally formed with and protruding from the first surface. A back plate portion has a plurality of receptacles for receiving the plurality of pins of the modular LGP element to fix the modular LGP element to the back plate portion. A backlight includes a plurality of the described backlight units, wherein the modular LGP elements are arranged in a two dimensional array, and the back plate portions form a common back plate to which the modular LGP elements are fixed. The backlight including the described backlight units may be incorporated into a liquid crystal display device.

### TECHNICAL FIELD

The invention relates to a display device, and more particularly a backlight unit for a display device incorporating a number of light guides, which is used in said display device. Furthermore, the invention relates to the configuration of said light guides and structures and methods for mechanically fixing said light guides in the backlight unit. In addition, the invention relates to the arrangement of Light Emitting Diodes (LEDs) used in said backlight unit.

### BACKGROUND ART

FIG. 1 depicts a conventional liquid crystal display (LCD) device. In general, a conventional LCD includes a liquid crystal panel (LC panel) 5 and a backlight unit (BLU) behind said LC panel 5 which illuminates the LC panel 5. As is known in the art, the LC panel 5 spatially and temporally modulates the transmission of the light from the BLU in intensity and color through its pixel and sub-pixel structure by making use of the polarisation modulation properties of the liquid crystals contained in said sub-pixels. A bright white and highly uniform backlight is generally needed to achieve good picture quality of the LCD. However, due to the LC panel 5 not being a perfect spatial light modulator, light losses occur and a completely dark pixel is generally not achievable when the BLU illuminates said pixel. For this reason, the contrast ratio of LCDs with a BLU that is only globally dimmable is limited, which in turn reduces the picture quality of such displays.

The advent of the LED as a light source in LCD BLUs has led to a diversification of BLU technologies into direct lit BLUs and edge lit BLUs. As also depicted in FIG. 1, direct lit BLUs typically include a two dimensional array of LEDs 2 arranged on the BLU's back plate 1 behind the LC panel 5, and also behind one or more optical sheets 4 and a diffuser sheet 3 as are known in the art.

The arrangement of the LEDs into a two dimensional array 2, and the direct relationship between sub-ensembles of said two dimensional array to an overlying area of the LC panel 5, enables a technology called “local dimming” for LCDs using direct lit BLUs. In a local dimming BLU, the areas of the BLU which are illuminating areas of the LCD that are currently in a low transmission mode are dimmed in order to reduce light leakage through the LC panel 5. Areas of the BLU illuminating areas of the LC panel 5 that are currently in strong transmission mode, on the other hand, are not dimmed. LCDs using a local dimming backlight can achieve very strong spatial brightness modulation, and therefore high picture quality.

The conventional direct lit BLU of FIG. 1 includes the back plate 1, which is equipped with a reflective film or coating. On said back plate 1, the light sources are arranged in the referenced two dimensional array 2. This allows control of the brightness of individual light sources or of sub-ensembles of the two dimensional array of light sources 2. In this way, the sub-ensemble of light sources illuminating an area of the LC panel 5 which is in a low transmission state can be dimmed, whereas the remaining light sources continue providing bright illumination of the other areas of the LC panel 5. To achieve uniform illumination of the LC panel, however, the two dimensional array of light sources 2 has to be placed a relatively large distance away from the LC panel 5, which produces relatively thick LCD systems. To further improve the uniformity and efficiency of said direct lit BLU, a diffuser sheet 3 and one or more optical sheets 4 also are commonly used.

Accordingly, although direct lit BLUs are able to work as local dimming BLUs, such a configuration has a disadvantage of requiring large distances between the LC panel 5 and the back plate 1, on which the two dimensional array of LEDs 2 is arranged, to allow the light of adjacent LEDs to mix and provide sufficient uniformity at the LC panel 5. This in turn undesirably provides a limit to the thinness of the LCD system.

In contrast, edge lit BLUs enable very thin LCD systems by using a light guide plate (LGP) and LEDs arranged in linear arrays on the periphery of said LGP. FIG. 2 depicts a partial cross section of a conventional edge lit BLU. The light of said LEDs is shone into the LGP and mixed due to refraction and propagation within the planar LGP, which is essentially parallel to the LC panel. Geometrical disturbances of the LGP, e.g. prismatic holes or lenticular surface features, as well as scattering surface features on the LGP's surface or dispersed in the LGP's volume, are used to extract the light uniformly from the LGP. Optical sheets are then used to efficiently direct the light towards the LC panel. However, due to the highly distributed nature of the illumination in edge lit BLUs, local dimming operation is substantially limited in edge lit BLUs using a single LGP.

As depicted in FIG. 2, recently the edge lit BLU technology has been expanded by using an array of modular LGPs 9a, each equipped with LEDs 6 that provide light only for their associated LGP 9a. Although FIG. 2 depicts only two such modular LGPs 9a, it will be appreciated that numerous LGPs may be arranged in array configurations. Each of said modular LGPs 9a covers part of the LCD's area, and therefore an additional means of mechanically fixing the modular LGPs 9a is required, as the frame around the display's area cannot be used for such fixing.

FIG. 2 is a partial cross sectional view illustrating a conventional mechanical means of fixing modular LGPs 9a within an edge lit BLU. The modular LGPs 9a are placed on a reflector sheet 7 that is positioned on the BLU's back plate 1. Holes through the modular LGPs 9a, the reflector sheet 7, and the back plate 1 are aligned, and fixation units 8 reaching through these structures are used to bolt down the modular LGPs 9a and the reflector sheet 7 onto the back plate 1 to hold them in place. The associated light sources or LEDs 6 are placed in the spaces between adjacent modular LGPs 9a. In addition, one or more optical sheets 4 are placed on top of the fixation units 8 to improve uniformity and efficiency. The use of through holes and fixation units 8 to hold the modular LGPs 9a, however, introduces strong non-uniformities and light loss channels resulting in reduced picture quality and efficiency of the LCD. Although this arrangement allows for very thin LCD systems, the strong non-uniformities due to the holes through the modular LGPs 9a and the fixation units 8 used in these holes represents a substantial disadvantage of such systems.

### SUMMARY OF INVENTION

Current local dimming BLUs in LCD systems are either of the direct lit variety, with a two dimensional array of LEDs behind the LC panel, or of the modular LGP variety, in which modular LGPs with individually associated light sources are arranged in a two dimensional array behind the LC panel. The first technology limits the thinness of the LCD system due to the necessity of sufficient light mixing to achieve uniformity, and the latter technology introduces strong non-uniformities due to the mechanical fixing units required to hold the modular LGPs in place.

The current invention overcomes the referenced deficiencies of the described conventional configurations. The current invention generally is an improved edge lit modular LGP based BLU and an LCD system using said BLU. More particularly, the current invention includes a modular LGP with two major surfaces, a first or bottom surface which faces the BLU's back plate, and a second or top surface which faces the LC panel. In addition, said modular LGP has pins protruding out of the first or bottom surface. In contrast to the separate fixing units of the described conventional configurations, the pins of the current invention are formed integrally as part of said modular LGP, and these pins thus may be made of the same material as said modular LGP. Furthermore, these pins are used to mechanically fix the modular LGP on the BLU's back plate, which is equipped with corresponding holes or receptacles to receive the pins of the modular LGPs. Furthermore, said modular LGPs may feature a complex shape of the bottom surface to aid efficient light extraction and improve uniformity. Because these modular LGPs do not have through holes and no separate fixation units are used, a more efficient and uniform illumination of the LGP panel is possible.

Accordingly, one aspect of the invention is a backlight unit. Exemplary embodiments of the backlight unit include a light source; at least one modular light guide plate (LGP) element that guides light from the light source, wherein the modular LGP element has a first surface and a plurality of pins integrally formed with and protruding from the first surface; and a back plate portion having a plurality of receptacles for receiving the plurality of pins of the modular LGP element to fix the modular LGP element to the back plate portion.

In another exemplary embodiment of the backlight unit, the plurality of pins are conical pins that narrow or widen protruding from the first surface, and the plurality of receptacles are conically shaped oppositely to the plurality of pins.

In another exemplary embodiment of the backlight unit, the plurality of pins each has a hole for receiving a fixing element to fix the pin into a corresponding one of the receptacles of the back plate portion.

In another exemplary embodiment of the backlight unit, the plurality of pins each has a slot for receiving an oppositely shaped feature of a corresponding one of the receptacles of the back plate portion.

In another exemplary embodiment of the backlight unit, the plurality of pins each has a notch for press fitting the plurality of pins into the plurality of receptacles of the back plate portion.

In another exemplary embodiment of the backlight unit, the backlight unit further includes a first set of local tapers, wherein the first set of local tapers includes at least one taper formed locally relative a corresponding one of the plurality of pins.

In another exemplary embodiment of the backlight unit, the backlight unit further includes a global taper formed in the bottom surface of the modular LGP element.

In another exemplary embodiment of the backlight unit, the global taper has at least one of a triangular prismatic shape, a polygon prismatic shape, or a rounded shape.

In another exemplary embodiment of the backlight unit, the light source includes a plurality of light emitting diodes (LEDs) arranged along two opposite sides of the modular LGP element.

In another exemplary embodiment of the backlight unit, the number of LEDs is equal to the number of pins, and the LEDs are arranged along the opposite sides of the modular LGP element in an alternating manner with the pins.

In another exemplary embodiment of the backlight unit, the backlight unit further includes a second set of local tapers, wherein each one of the second set of local tapers is aligned with a corresponding LED.

In another exemplary embodiment of the backlight unit, each one of the second set of local tapers has at least one of a symmetric or an asymmetric polygon prismatic shape.

In another exemplary embodiment of the backlight unit, the modular LGP element further includes at least one overhang that overhangs a corresponding one of the LEDs.

In another exemplary embodiment of the backlight unit, the light source includes a plurality of light emitting diodes (LEDs) arranged at two opposing corners of the modular LGP element.

In another exemplary embodiment of the backlight unit, the modular LGP element further includes a second surface opposite the first surface, and light extraction features formed on the second surface.

In another exemplary embodiment of the backlight unit, the light extraction features are at least one of scattering extraction features, lenticular or cylindrical extraction features, prismatic or conical extraction features, or rectangular extraction features.

Another aspect of the invention is a backlight that includes a plurality of the described backlight units.

In another exemplary embodiment of the backlight, the modular LGP elements are arranged in a two dimensional array, and the back plate portions form a common back plate to which the modular LGP elements are fixed.

Another aspect of the invention is a liquid crystal display (LCD) device. An exemplary embodiment of the LCD device includes a backlight including a plurality of the described backlight units, wherein the modular LGP elements are arranged in a two dimensional array, and the back plate portions form a common back plate to which the modular LGP elements are fixed; and an LCD panel.

In another exemplary embodiment of the LCD device, the LCD device further includes, between the backlight and the LCD panel, at least one optical sheet and a diffuser sheet.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 is a schematic diagram depicting a conventional LCD with a direct lit backlight which is able to provide local dimming.

FIG. 2 is a schematic diagram depicting a conventional tiled backlight in which the light guide tiles are fixed using through holes and separate fixation units.

FIG. 3 is a schematic diagram depicting a large area backlight including an array of modular elements providing local dimming control in accordance with embodiments of the current invention.

FIGS. 4a and 4b are schematic diagrams depicting two perspectives of an exemplary modular element to be used in a backlight unit in accordance with embodiments of the current invention.

FIG. 4c is a schematic diagram depicting the modular element of FIGS. 4a and 4b secured to a back plate portion.

FIGS. 5a and 5b are schematic diagrams depicting two perspectives of an exemplary modular element to be used in a backlight unit in accordance with embodiments of the current invention.

FIG. 5c is a schematic diagram depicting the modular element of FIGS. 5a and 5b secured to a back plate portion.

FIGS. 6a-f are schematic diagrams depicting different exemplary shapes of pins protruding from an LGP in accordance with embodiments of the current invention.

FIGS. 7a-d are schematic diagrams depicting different exemplary shapes of holes or receptacles in the back plate of a backlight unit in accordance with embodiments of the current invention.

FIGS. 8a-c are schematic diagrams depicting different exemplary configurations of global tapers in an LGP in accordance with embodiments of the current invention.

FIGS. 9a and 9b are schematic diagrams depicting a top view of an exemplary modular element to be used in a backlight unit in accordance with embodiments of the current invention.

FIGS. 10a-d are schematic diagrams depicting different exemplary light extraction features to be used on LGPs in accordance with embodiments of the current invention.

FIGS. 11a and 11b are schematic diagrams depicting two perspectives of an exemplary modular element to be used in a backlight unit in accordance with embodiments of the current invention.

FIGS. 12a and 12b are schematic diagrams depicting two perspectives of an exemplary modular element to be used in a backlight unit in accordance with embodiments of the current invention.

### DESCRIPTION OF REFERENCE NUMERALS

1 back plate or back plate portion

2 array of light emitters

3 diffuser sheet

4 optical sheets

5 LC panel

6 light source (e.g. LED)

7 reflector sheet

8 fixation units

9, 9a different modular LGPs

10 modular element for the use in a backlight unit

11 pin

11a-f different shapes of pins

12 conical taper

13 internal hole (threaded or unthreaded) of a pin

14 slot in a pin

15 circular notch in a pin

16 holes or receptacles in the back plate of the backlight unit

16a-d different shapes of receptacles to receive LGP pins in the back plate of a backlight unit

17a-c different shapes of global tapers in modular LGPs

18a-c different shapes of local tapers in modular LGPs

19a-c different areas of a local taper in modular LGPs

20 scattering extraction features

21 lenticular or cylindrical extraction features

22 prismatic or conic extraction features

23 rectangular extraction features

24 overhang of a modular LGP to cover light sources

25 flat light injection surface

29 first or bottom LGP surface

30 second or top LGP surface

31 backlight unit

### DETAILED DESCRIPTION OF INVENTION

In the following, a description of the current invention is provided with reference to the attached drawings. In such drawings, reference numerals identify similar or identical elements throughout several views.

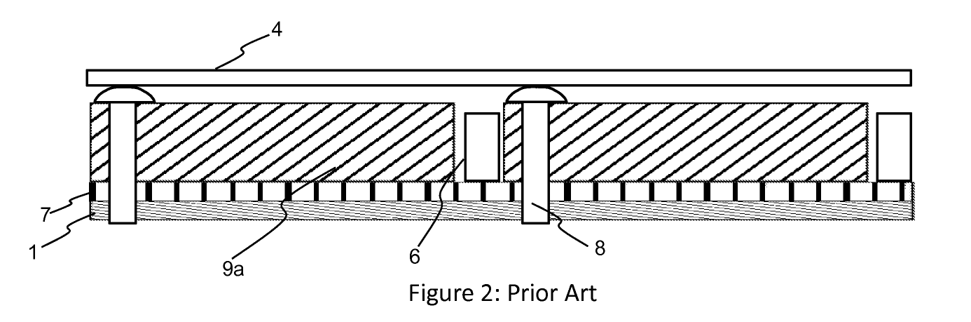

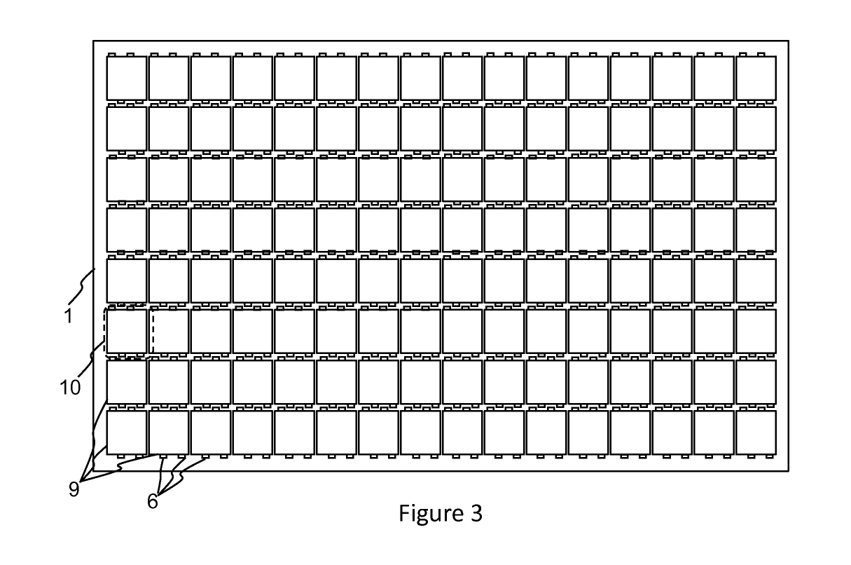

FIG. 3 is a schematic diagram depicting a top view of an exemplary large area backlight in accordance with embodiments of the current invention. The backlight includes a two dimensional array of modular LGPs 9 that guides light received from associated light sources 6 as they are used in a local dimming BLU for an LCD system in accordance with embodiments of the current invention. Each modular LGP unit 9 and its associated light sources 6 form a modular LGP element 10. The two-dimensional array of modular LGP elements 10 may be secured to a back plate 1. As is understood by those skilled in the art, the back plate may be provided with a conventional reflective surface, such as, for example, a coincident reflector sheet such as the reflector sheet 7 depicted in FIG. 2.

As depicted in the exemplary embodiment of FIG. 3, each modular LGP 9 has four associated light sources or LEDs 6; however a larger or smaller number of light sources are possible as well in accordance with embodiments of the current invention. The light sources 6 associated with an individual modular LGP 9 are arranged on two opposite side surfaces of the modular LGP 9 in such a way that opposing light sources 6 are spatially shifted with respect to each other to provide a uniform flux of light within the modular LGP 9. As further described below, the modular LGP 9 of the current invention does not require through holes or separate fixation units to be mechanically fixed to the BLU's back plate 1 as in conventional configurations. Said modular LGP 9 and its associated light sources 6 in combination form a modular element 10 of the BLU in accordance with embodiments of the current invention.

The two-dimensional array of modular elements 10 of FIG. 3 may be subjected to local dimming control. As is understood by those skilled in the art, local dimming control typically may be performed by temporal control of the local light emission of the local dimming backlight in order to support the current transmission state of the LC panel. This means that the local dimming backlight will provide less light to low transmission areas of the LC panel in order to support the contrast ratio achieved by the display device.

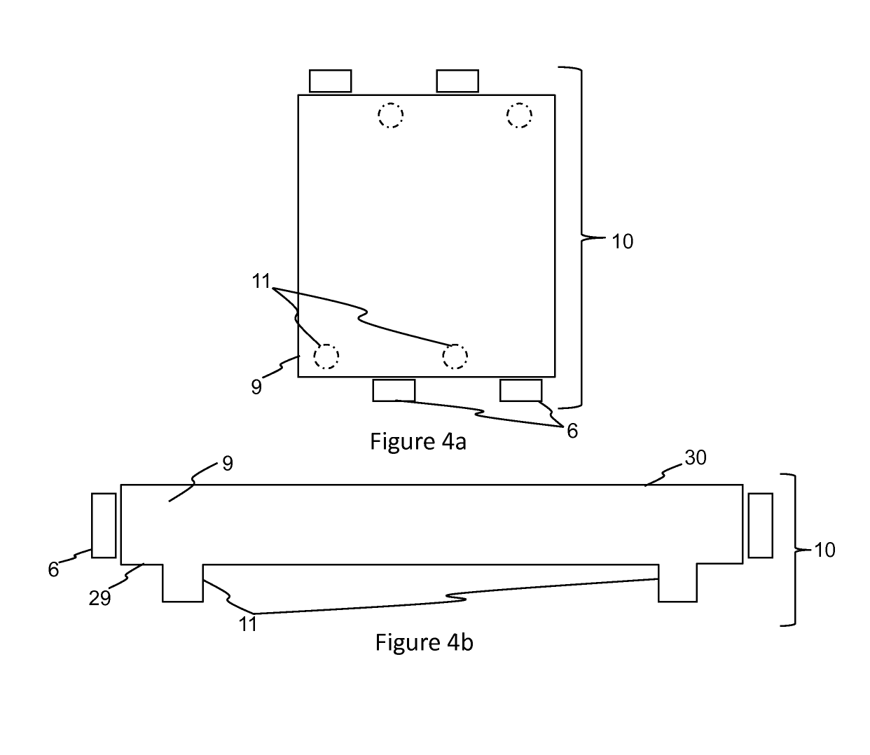

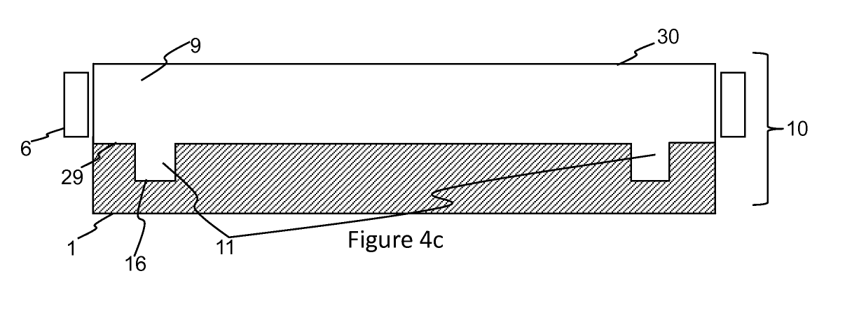

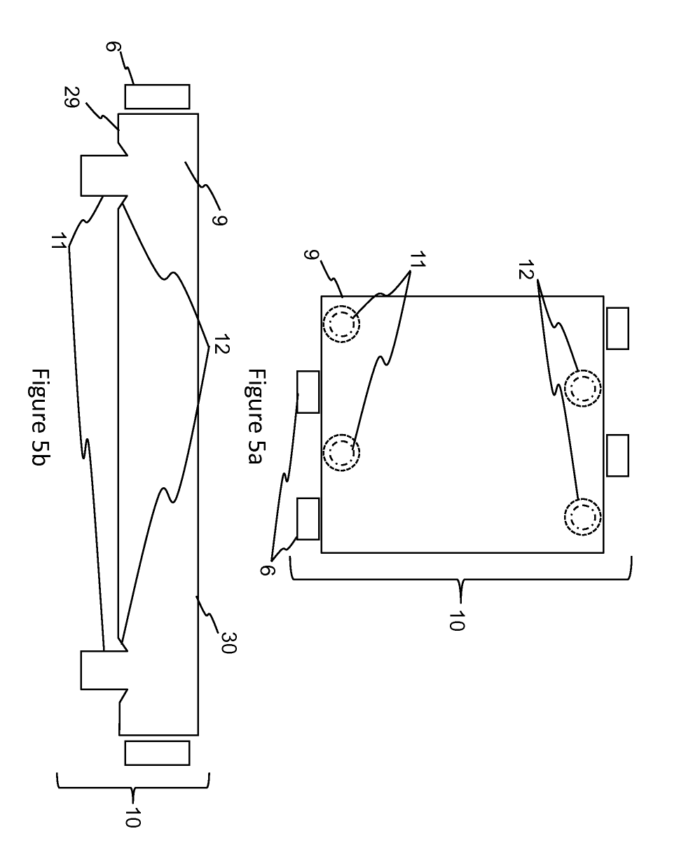

FIGS. 4a and 4b are schematic diagrams depicting different perspective views of an exemplary modular element 10. More specifically, the modular element 10 is depicted in further detail in FIG. 4a in a top view, and in FIG. 4b in a cross sectional view. The modular element 10 has a modular LGP 9 including a first or bottom surface 29 and a second or top surface 30 opposite the first or bottom surface. The modular LGP 9 is equipped with a plurality of pins (in this example four pins) 11, integrally formed with and protruding from its first or bottom surface 29. As further described below, said pins 11 are received by a plurality of holes or receptacles 16 in the BLU's back plate 1 and used to mechanically fix the modular LGP 9 to the back plate 1. The light sources (e.g., LEDs) 6 may be equal in number to the plurality of pins 11, and in this embodiment are arranged along two opposite edges of the modular LGP 9 in an alternating manner with the pins 11. Although in this first embodiment of the current invention the modular element 10 has four light sources and four pins, the invention is not limited by such configuration and alternative embodiments may employ a larger or smaller number of light sources and corresponding pins.

As referenced above, the pins 11 are formed integrally with the first or bottom surface 29 of the modular LGP 9 so as to protrude from the first or bottom surface 29 of the LGP 9. Said integrally formed pins 11 of the modular LGP 9 can be produced using conventional casting, molding or rapid manufacturing techniques. The said modular LGP 9 is preferably made of Polymethyl methacrylate or Polycarbonate; however any other solid transparent dielectric can be used as well. Accordingly, the current invention obviates the need for through holes through the LGP and separate fixation units as are employed in conventional configurations. As a result, the current invention avoids the strong non-uniformities and light losses that occur in the conventional configurations.

As seen in FIG. 4c, a backlight unit may include the modular element 10 that is fixated to a back plate portion 1. The back plate portion 1 may include a plurality of holes or receptacles 16, each for receiving a corresponding pin 11. A principal purpose of the pins 11 protruding from the bottom surface of the LGP 9 is to allow mechanical fixing of the modular LGP 9 to the back plate portion 1. The fixation can be achieved by a number of methods including, for example, using a screw, sliding onto a rib on the back plate portion 1, holding by a collar, mechanically snapping form fitting structures together, and/or by any suitable mechanical method of mechanically fixing the modular LGP 9 to the back plate portion 1 using the pins 11 cooperating with the receptacles 16.

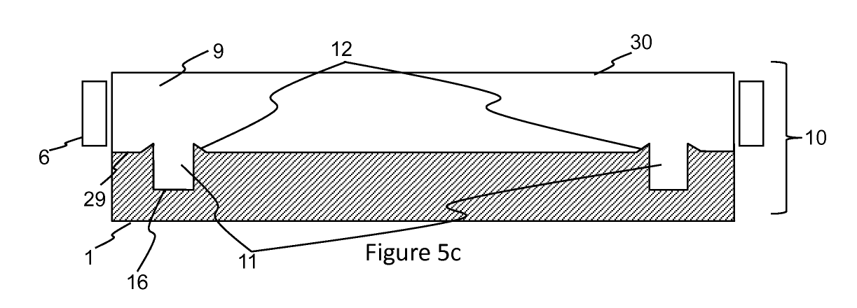

FIGS. 5a and 5b are schematic diagrams depicting different perspective views of another exemplary modular element 10. More specifically, this embodiment of the current invention is shown in FIG. 5a in a top view, and in FIG. 5b in a cross sectional view. The embodiment of FIGS. 5a and 5b is comparable to that of FIGS. 4a and 4b, except that the pins 11 in the embodiment of FIGS. 5a and 5b have an additional conical local taper 12. In particular, a first set of local tapers 12 each may be formed locally relative to a corresponding one of the plurality of pins 11. Each said conical taper 12 allows redirecting the light to avoid losses out of the pins' 11 side walls, and therefore said conical tapers can improve uniformity and efficiency. In FIGS. 5a and 5b, the conical tapers are depicted as being on all four pins and of the same shape. However, different shapes for individual conical tapers 12 around pins 11 on a modular LGP 9 may be employed in accordance with embodiments of the current invention.

In addition, similarly to FIG. 4c, FIG. 5c depicts a backlight unit in which the modular LGP element 10 may be fixated to a back plate portion 1. The back plate portion 1 may include a plurality of holes or receptacles 16, each for receiving a corresponding pin 11.

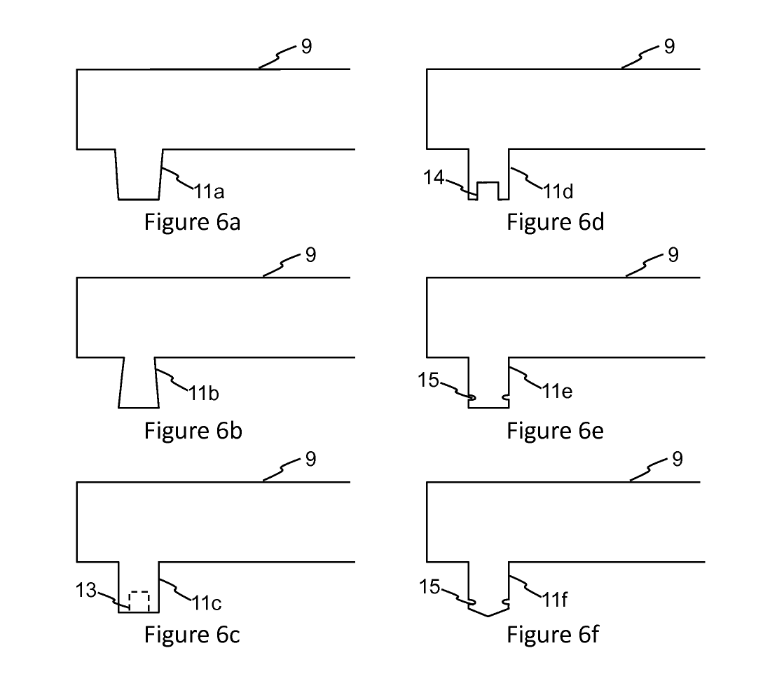

FIGS. 6a-f are schematic diagrams depicting partial cross sectional views of further exemplary embodiments of the pins 11 of the LGP 9 of the current invention. In previous embodiments, the pins 11 were shown to be cylindrical; however the pins 11 may be provided with varied shapes and configurations. For example, conical pins 11a that narrow protruding from the first or bottom surface of the LGP 9 may be provided as seen in FIG. 6a, or conical pins 11b that widen protruding from the first or bottom surface of the LGP 9 may be provided as seen in FIG. 6b. FIGS. 6c - 6f show additional embodiments of the pins 11 that may facilitate mechanical fixing to the back plate portion. Pins 11c protruding from a modular LGP 9 may be equipped with holes 13 to enable a fixing element, such as a screw or bolt, to be used to mechanically fix the pin of the modular LGP 9 into a corresponding one of the receptacles in the back plate 1. In an additional embodiment, pins 11d, each has a slot 14 that allows the modular LGP 9 to slot onto a suitable oppositely shaped feature of a corresponding one of the receptacles on the back plate 1 to mechanically hold said modular LGP 9 in place. Other embodiments of the pins 11e and 11f may include a circular notch 15 that allows press fitting the modular LGP 9 through undersized holes in the corresponding receptacles of the back plate 1. The described embodiments of the pins 11a-11f are exemplary and do not represent a complete set of embodiments covered by the current invention. Indeed, any suitable shape or configuration of a pin 11 integrally protruding from the bottom surface 29 of the modular LGP 9 may be employed to mechanically fix said modular LGP 9 in place is in accordance with embodiments of the current invention.

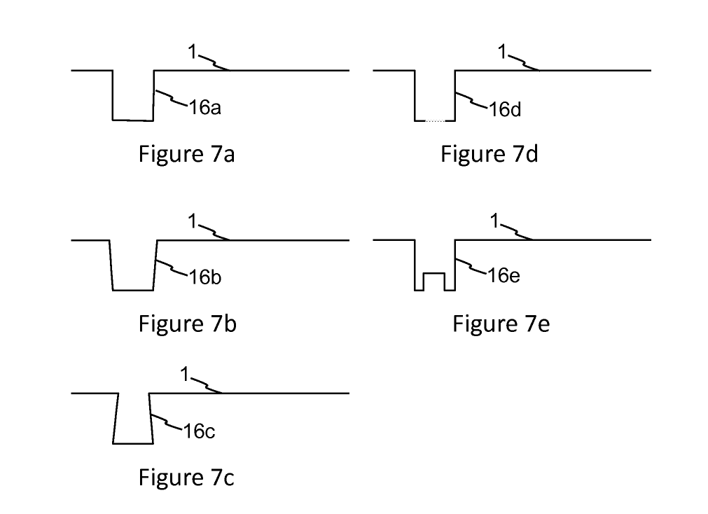

As earlier described, the pins 11 integrally protruding from the first or bottom surface 29 of the modular LGP 9 are received by holes or receptacles 16 in the back plate portion 1. FIGS. 7a-7e are schematic diagrams depicting partial cross sections of embodiments of holes or receptacles 16a-16e having various shapes or configurations. The different embodiments for said holes include: straight cylindrical holes 16a, tapered cylindrical holes with decreasing (16b) or increasing (16c) radius, cylindrical holes with an opening 16d to allow the use of a bolt or screw, and cylindrical holes with a slotted configuration 16e. Essentially, the holes or receptacles 16 may be configured so as to cooperate with correspondingly shaped or configured pins 11 as described above with respect to FIGS. 6a-f. As with the pins 11, it will be appreciated that the current invention is not limited to these particular shapes and configurations of the holes or receptacles 16, and that variations in the shapes and configurations of the holes or receptacles 16 in the back plate portion 1 may be employed to receive the pins 11 to mechanically fix the modular LGP 9 to the back plate portion 1.

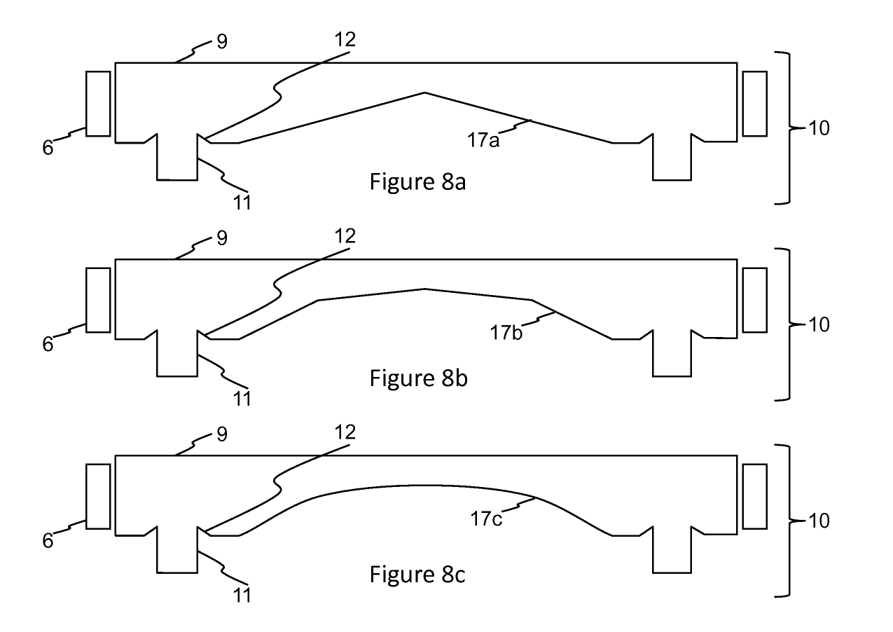

FIGS. 8a-8c are schematic diagrams depicting partial cross sectional views of another exemplary modular element 10 in accordance with additional embodiments of the current invention. As described earlier, a first set of local tapers 12 around the pins 11 can be used to increase illumination uniformity and efficiency. In addition to such tapers 12 positioned locally relative to the pins 11, a global taper, such as one of the global tapers 17a-17c, can be used to increase overall illumination uniformity and efficiency of the system. A global taper may be formed in the bottom surface 29 of the modular LGP 9. As shown in FIG. 8a-8c, for example, these global tapers can have a triangular prismatic shape 17a, a polygon prismatic shape 17b, or a rounded shape 17c; however the current invention is not limited to these shapes and other variations of shapes and configurations may be employed.

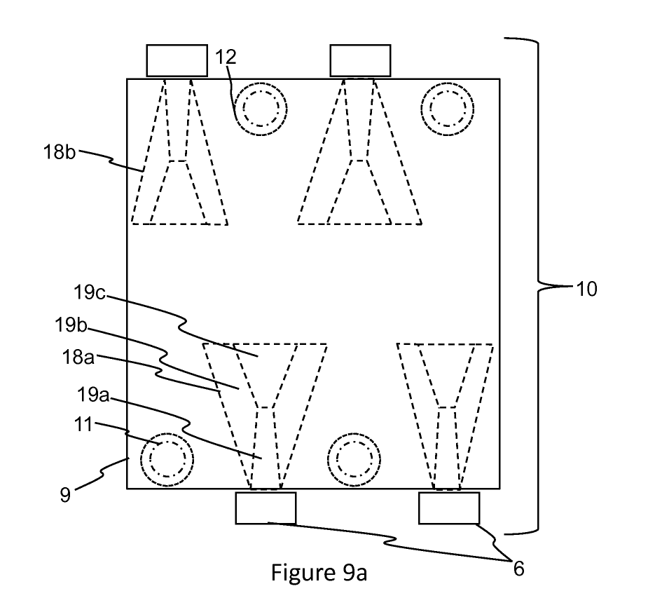

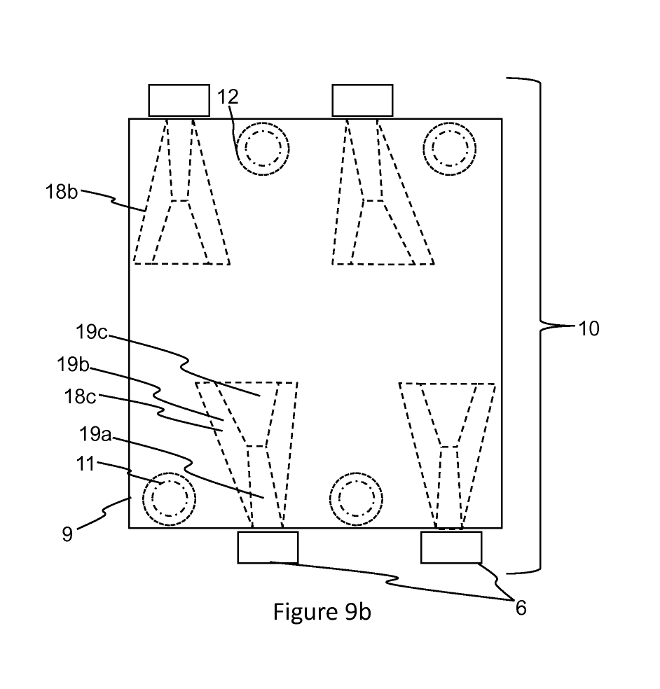

FIGS. 9a and 9b are schematic diagrams depicting partial top views of another exemplary modular element 10 in accordance with additional embodiments of the current invention. In addition to the first set of local tapers 12 around the pins 11 similarly to previous embodiments, the embodiment of FIGS. 9a and 9b further may include a second set of local tapers 18a-18c. Such second set of local tapers each may be aligned with a corresponding one of the plurality of LEDs 6 to improve efficiency and illumination uniformity. Each of said local tapers 18 may have a polygon prismatic shape with a front surface 19a, side surfaces 19b and a top surface 19c; however embodiments of the current invention are not limited to this shape and other shapes and configurations may be employed. Due to the asymmetric arrangement of the LEDs 6 around the edges of the modular LGP 9, the geometry of said local tapers 18a - 18c may be different with respect to each other as well. For example, local tapers 18a may be larger than smaller local tapers 18b, and/or asymmetric local tapers such as local taper 18c (see FIG. 9b in particular) can be used on the same modular LGP 9.

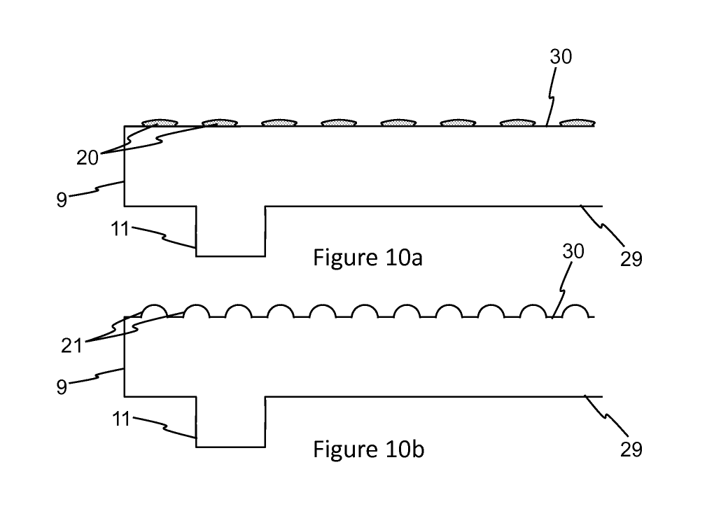

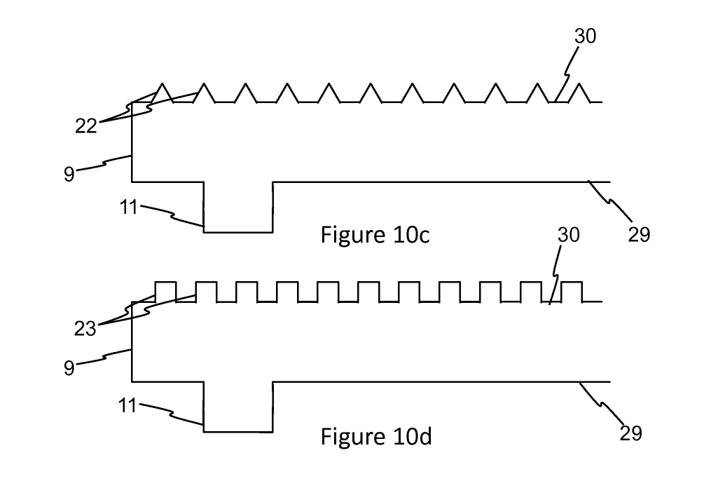

FIGS. 10a - 10d are schematic diagrams depicting partial cross sectional views of additional embodiments of the current invention employing additional light extraction features. Additional light extraction features can be used to achieve illumination uniformity and efficiency in addition to the enhancements provided in part by the global and local tapers described with respect to previous embodiments. As stated above, the modular LGP 9 may include a second or top surface 30 opposite the first surface 29, and light extraction features may be formed on the second surface. Said additional light extraction features may be exemplified by at least any of the following: scattering extraction features 20 (FIG. 10a), that rely on optical scattering to extract light from the modular LGP 9; lenticular or cylindrical extraction features 21 (FIG. 10b); prismatic or conical extraction features 22 (FIG. 10c), or rectangular extraction features 23 (FIG. 10d). The latter three configurations rely on geometrical deviations from a flat surface to extract light from the modular LGP 9. It will be appreciated that the current invention is not limited to these extraction feature configurations, and other suitable extraction features relying on optical scattering, geometrical deviations from a flat surface, or a combination thereof may be employed.

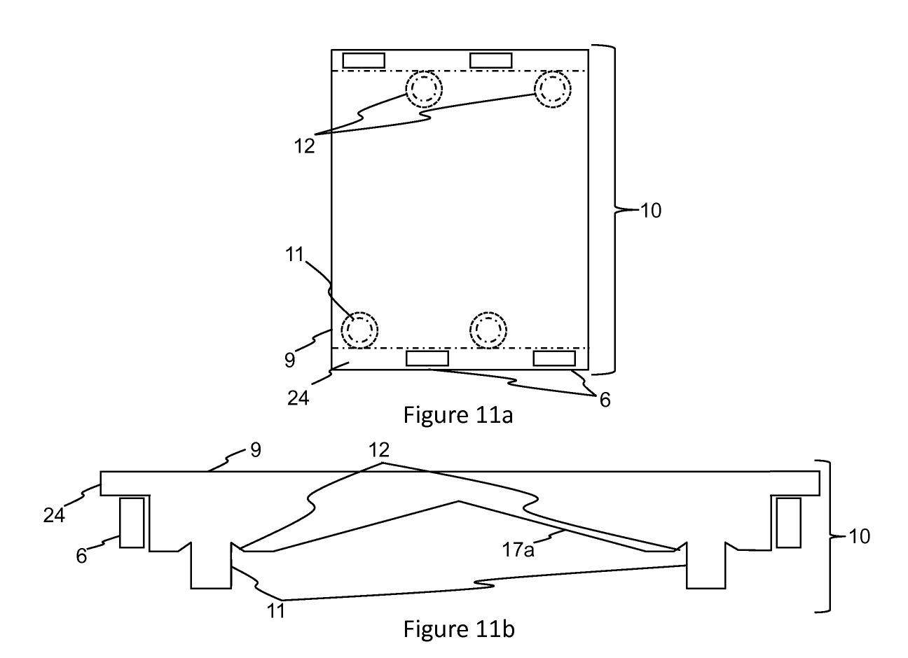

FIGS. 11a and 11b are schematic diagrams depicting different perspective views of another exemplary modular element 10. More specifically, this embodiment of the modular element 10 is shown in FIG. 11a in a top view, and in FIG. 11b in a cross sectional view. In this embodiment, at least one overhang 24 of the modular LGP 9 is used to cover a corresponding one of the light source(s) LEDs 6 to provide a seamless coverage of the array of modular LGPs 9 over the whole area of the BLU. This allows reducing brightness non-uniformity due to gaps between individual modular elements 10 constituting the BLU.

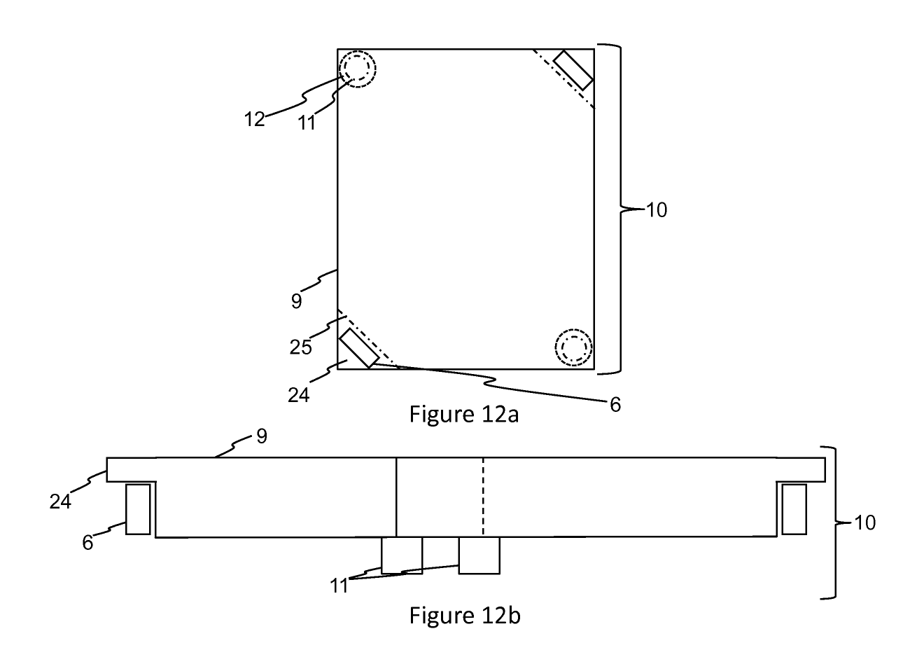

FIGS. 12a and 12b are schematic diagrams depicting different perspective views of another exemplary modular element 10. More specifically, this embodiment of the modular LGP element 10 is shown in FIG. 12a in a top view, and in FIG. 12b in a cross sectional view. In this embodiment, the arrangement of the light sources 6 along two opposite edges of the rectilinear modular LGP 9 has been changed and the light sources are arranged at two opposing corners of the modular LGP 9. At said corners overhangs 24 are created in order receive the light sources 6 and flat light injection surfaces 25 are created to provide a controlled light injection surfaces for the light sources 6. The described deviation from the earlier geometrical arrangement makes it necessary to rearrange the pins 11 and the first set of conical tapers 12, which are located in this embodiment in the two corners not used by the light sources 6. Although not specifically illustrated in FIGS. 12a and 12b, it will be appreciated that global tapers or the second set of local tapers may also be employed in conjunction with the embodiment of FIGS. 12a and 12b.

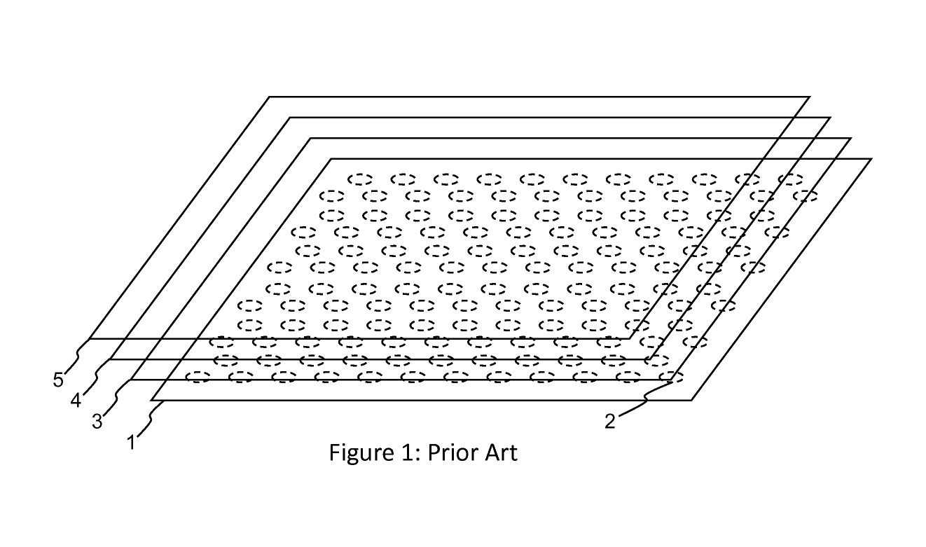

The various embodiments of the modular element 10 may be employed in an LCD device, such as an LCD display device. For example, a backlight may include a plurality of the BLUs including modular elements 10 configured in a two dimensional array fixed to contiguous back plate portions that form a common back plate 1 as depicted in FIG. 3. The backlight of FIG. 3 in turn may be incorporated into an LCD display device. Such an LCD display device may incorporate other more conventional components as described above with respect to FIG. 1. For example, embodiments of the BLU of the current invention, including a two-dimensional array of modular elements 10 secured to a back plate 1, may be arranged behind an LC panel 5, and between the LCD panel and the backlight there may also be at least one optical sheet 4 and a diffuser sheet 3.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

Applications for the described invention include large area LCD backlights. These LCD backlights typically are used in TVs or digital signage displays of 37 inches or larger sizes. The invention has the benefit of allowing local dimming of the BLU, which allows reducing the power requirements of the LCD employing the BLUt. This is an important requirement for current and future LCD systems due to energy standards and policy restrictions. Furthermore, a locally dimming BLU allows improving the picture quality of the LCD system, and the invention enables very thin system dimensions not achievable with direct lit local dimming BLUs.

Other applications of the described invention may include the lighting market, which is currently experiencing a move towards LED illumination. The current invention represents an exploitation of the new form factors available due to the small size of the LEDs.

1. A backlight unit comprising:
a light source;
at least one modular light guide plate (LGP) element that guides light from the light source, wherein the modular LGP element has a first surface and a plurality of pins integrally formed with and protruding from the first surface; and
a back plate portion having a plurality of receptacles for receiving the plurality of pins of the modular LGP element to fix the modular LGP element to the back plate portion.

2. The backlight unit according to claim 1, wherein the plurality of pins are conical pins that narrow or widen protruding from the first surface, and the plurality of receptacles are conically shaped oppositely to the plurality of pins.

3. The backlight unit according to claim 1, wherein the plurality of pins each has a hole for receiving a fixing element to fix the pin into a corresponding one of the receptacles of the back plate portion.

4. The backlight unit according to claim 1, wherein the plurality of pins each has a slot for receiving an oppositely shaped feature of a corresponding one of the receptacles of the back plate portion.

5. The backlight unit according to claim 1, wherein the plurality of pins each has a notch for press fitting the plurality of pins into the plurality of receptacles of the back plate portion.

6. The backlight unit according to claim 1, further comprising a first set of local tapers, wherein the first set of local tapers includes at least one taper formed locally relative a corresponding one of the plurality of pins.

7. The backlight unit according to claim 1, further comprising a global taper formed in the bottom surface of the modular LGP element.

8. The backlight unit according to claim 7, wherein the global taper has at least one of a triangular prismatic shape, a polygon prismatic shape, or a rounded shape.

9. The backlight unit according to claim 1, wherein the light source comprises a plurality of light emitting diodes (LEDs) arranged along two opposite sides of the modular LGP element.

10. The backlight unit according to claim 9, wherein the number of LEDs is equal to the number of pins, and the LEDs are arranged along the opposite sides of the modular LGP element in an alternating manner with the pins.

11. The backlight unit according to claim 9, further comprising a second set of local tapers, wherein each one of the second set of local tapers is aligned with a corresponding LED.

12. The backlight unit according to claim 11, wherein each one of the second set of local tapers has at least one of a symmetric or an asymmetric polygon prismatic shape.

13. The backlight unit according to claim 9, wherein the modular LGP element further comprises at least one overhang that overhangs a corresponding one of the LEDs.

14. The backlight unit according to claim 1, wherein the light source comprises a plurality of light emitting diodes (LEDs) arranged at two opposing corners of the modular LGP element.

15. The backlight unit according to claim 1, wherein the modular LGP element further comprises a second surface opposite the first surface, and light extraction features formed on the second surface.

16. The backlight unit according to claim 15, wherein the light extraction features are at least one of scattering extraction features, lenticular or cylindrical extraction features, prismatic or conical extraction features, or rectangular extraction features.

17. A backlight comprising:
a plurality of backlight units according to claim 1.

18. The backlight according to claim 17, wherein the modular LGP elements are arranged in a two dimensional array, and the back plate portions form a common back plate to which the modular LGP elements are fixed.

19. A liquid crystal display (LCD) device comprising:
a backlight comprising a plurality of backlight units according to claim 1, wherein the modular LGP elements are arranged in a two dimensional array, and the back plate portions form a common back plate to which the modular LGP elements are fixed; and
an LCD panel.

20. The LCD device according to claim 19, further comprising between the backlight and the LCD panel:
at least one optical sheet; and
a diffuser sheet.
